(19) United States
(12) Patent Application Publication
(10) Pub. No.: US 2013/0199170 A1
(43) Pub. Date: Aug. 8, 2013

(54) Hydraulic Drive with Energy Recovery

(71) Applicants: Uwe Neumann, Rochester Hills, MI (US); Jan Amrhein, Ditzingen (DE); Edwin Heemskerk, Margetshoechheim (DE)

(72) Inventors: Uwe Neumann, Rochester Hills, MI (US); Jan Amrhein, Ditzingen (DE); Edwin Heemskerk, Margetshoechheim (DE)

(73) Assignee: Robert Bosch GmbH, Stuttgart (DE)

(21) Appl. No.: 13/509,672

(22) PCT Filed: Sep. 14, 2010
(86) PCT No.: PCT/EP10/05633

§ 371 Date: Sep. 20, 2012

(30) Foreign Application Priority Data
Nov. 17, 2009 (DE) 10 2009 053 618.3

(51) Int. Cl. F15B 7/00

(52) U.S. Cl. CPC F15B 7/00
USPC 60/384

(57) ABSTRACT

A hydraulic drive device with energy recovery function, includes a pressure medium pump for supplying a consumer with pressure medium and a return line for removing the pressure medium from the consumer. The discharged pressure medium is returned under pressure to the suction side of the pressure medium pump.

The present invention relates to a hydraulic drive device for a translatory consumer, for example the boom/lifting mechanism of a machine such as an excavator, a stacker and similar working equipment, or a rotatory consumer, for example a cable winch, in each case with an energy recovery function, according to the preamble of patent claim 1.

Rotatory consumers such as cable winch drives or translatory consumers such as lifting mechanisms of machines are, inter alia, hydraulically driven, the flow of hydraulic fluid required for this being produced by a pressure medium pump. The pump is mechanically driven by a motor, its volumetric delivery being variable in dependence on a manually actuated control lever, either directly by mechanical means or indirectly by way of a control unit, which generates corresponding control signals and applies them to the pressure medium pump or the adjusting mechanism thereof. Additionally interposed in the connecting lines between the pump and the consumer is at least one manually actuable control valve, by way of which the speed and direction of movement of the consumer can be controlled. In this connection, it is also in keeping with the technical standard to set a speed of movement (for example the lowering speed in the case of a boom) in accordance with a valve lever position and to realize the maximum speed of movement, for example lowering speed, by way of a directional valve in a pressure relief line of the hydraulic drive device. The potential energy of the raised or hauled load is thereby converted into heat at a throttling point of the directional valve and is discharged into the tank with the fluid.

In particular in the case of electrically operated machines, but also generally in mobile hydraulics, however, the energy efficiency of the hydraulic plant is of great importance, in such cases the potential energy of raised loads being recovered, as they are lowered, into an electrical battery by way of an electric motor operating in the manner of a generator. It has become known in this respect in the prior art, for example according to DE 44 16 173 C2, to supply the lifting cylinder of a lifting device with hydraulic fluid by means of a variable-delivery pressure medium pump, which is connected to the lifting cylinder by way of a pressure medium line and an interposed control valve. The control valve can be manually actuated and connects the lifting cylinder optionally to the pressure medium pump for raising a load or to a pressure release line for lowering the load.

Interposed in the pressure release line is a lowering braking valve, by way of which the pressure medium can be released in a throttled manner into a pressure medium tank. In addition, an energy recovery line branches off from the pressure release line at a switch-over valve upstream of the lowering braking valve, returns by way of a check valve into the pressure medium line upstream of the pump and consequently carries back released pressure medium to the pressure medium pump at the output connection thereof. For the case where the pressure between the lifting cylinder and the control valve exceeds a predetermined value, the switch-over valve switches over to the energy recovery line. The pressure medium pump in this case operates as a pressure medium motor and the electric motor mechanically connected thereto operates as a generator.

A circuit with energy recovery according to the above prior art requires an electrically driven pump-motor unit with an electrical energy storage device (for example a battery). However, in mobile machines the hydraulic pumps are generally driven by the internal combustion engine.

Another disadvantageous aspect that may be mentioned is the comparatively complicated control equipment, with a large number of sensors, since the pump speed and the valve openings have to be controlled in dependence on system and consumer pressures and consumer speeds. Moreover, an energy recovery is not possible in operating states with parallel consumers, which have a higher consumer pressure.

In view of this situation, it is the object of the present invention to provide a hydraulic drive device with an energy recovery function that achieves high efficiency and can drive a number of parallel consumers. A further preferred aim is to design the hydraulic drive device such that an electrically driven pump-motor unit with an electrical energy storage device is not required and which can furthermore preferably be operated with uncomplicated control equipment.

This object is achieved by a hydraulic drive device with the features of patent claim 1. Advantageous refinements of the invention are the subject of the accompanying dependent claims.

The essence of the invention, and consequently the essential difference from the prior art, is to design the hydraulic drive device with an energy recovery function, comprising a pressure medium pump for supplying at least one or more (translatory or rotatory) consumer(s) with pressure medium and a return line for discharging the pressure medium from the consumer(s), such that the discharged pressure medium is returned under a (recovery) pressure to the suction side of the pressure medium pump. In this way, either the pressure difference over the pump is reduced, and consequently the energy consumption reduced, in the case where the pump is in pump mode, or the energy from the returned pressure medium is given off to the drive shaft, in the case where the pump is in motor mode. In both cases, an energy recovery therefore takes place, the recovered energy being available immediately and directly to consumers that are parallel and driven by the same pump. In this way, the efficiency of the drive device can be increased.

An advantageous refinement of the invention provides for this purpose interposing in the return line a pressure compensator, the output side of which is preloaded/can be preloaded to the (recovery) pressure by means of a pressure limiting valve. In this way, a load-independent (recovery) pressure can be applied to the suction side of the pump.

It is particularly advantageous to connect to the suction side of the pressure medium pump a pressure medium accumulator, in which volumetric flow not required/retrieved by the pump (recovery flow) can be temporarily stored.

Finally, it is advantageous to circumvent the pressure compensator by means of a bridge line, interposed in which is a throttling element, preferably a proportional valve. This achieves the effect that, when there is a correspondingly high return pressure in the return line, a (recovery) pressure above the output pressure set at the pressure compensator can be applied to the pump, in order temporarily to increase still further the efficiency of the drive device.

The invention is explained in more detail below on the basis of preferred exemplary embodiments with reference to the accompanying drawings.

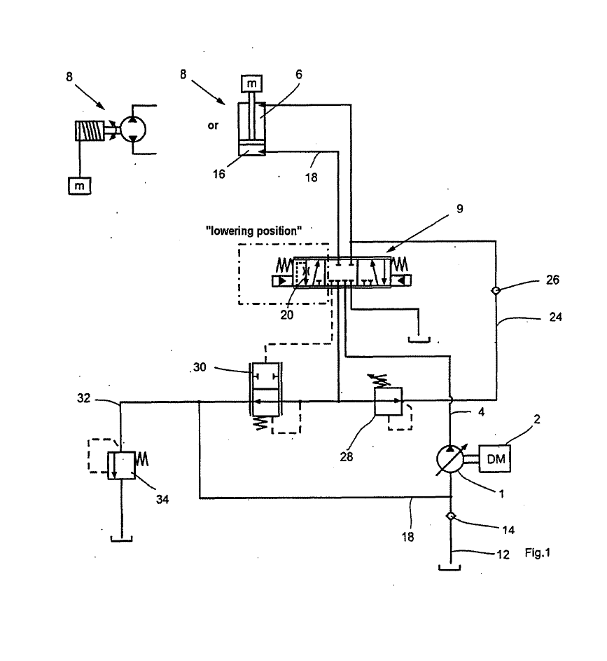

FIG. 1 shows the connection diagram of a hydraulic drive device according to a first preferred exemplary embodiment of the invention, which substantially represents a basic embodiment,

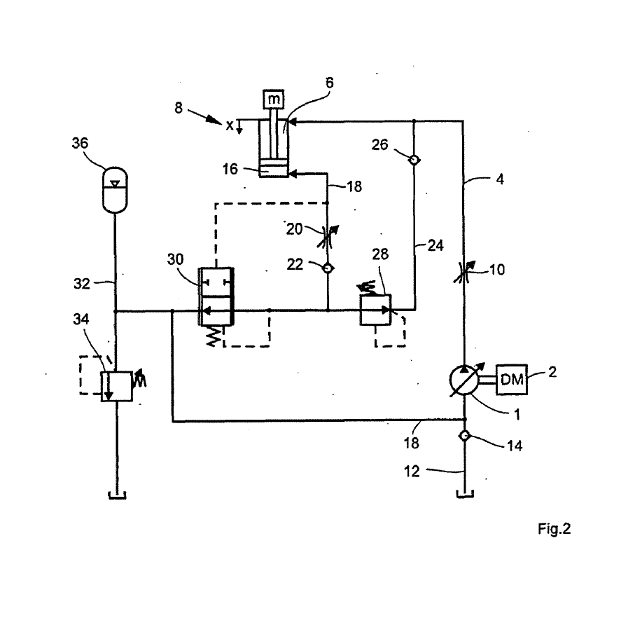

FIG. 2 shows the connection diagram of a hydraulic drive device according to a second preferred exemplary embodiment of the invention, which is equipped with an additional energy storage device for the recovered energy,

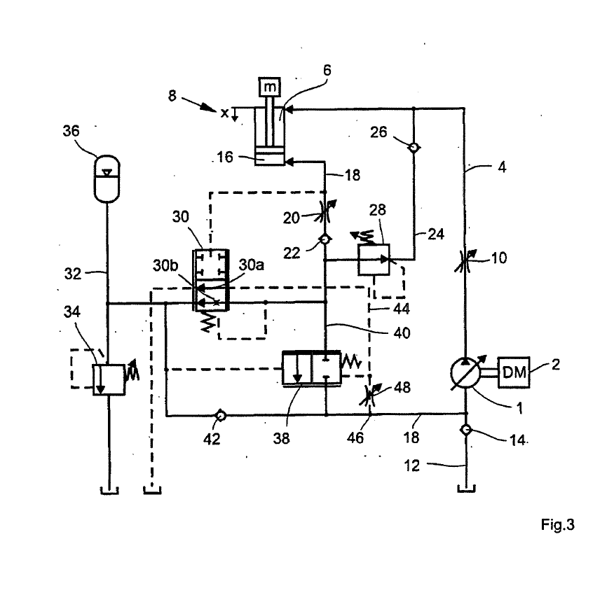

FIG. 3 shows the connection diagram of a hydraulic drive device according to a third preferred exemplary embodiment of the invention, which represents a development of the second exemplary embodiment and further improves the efficiency of the drive device,

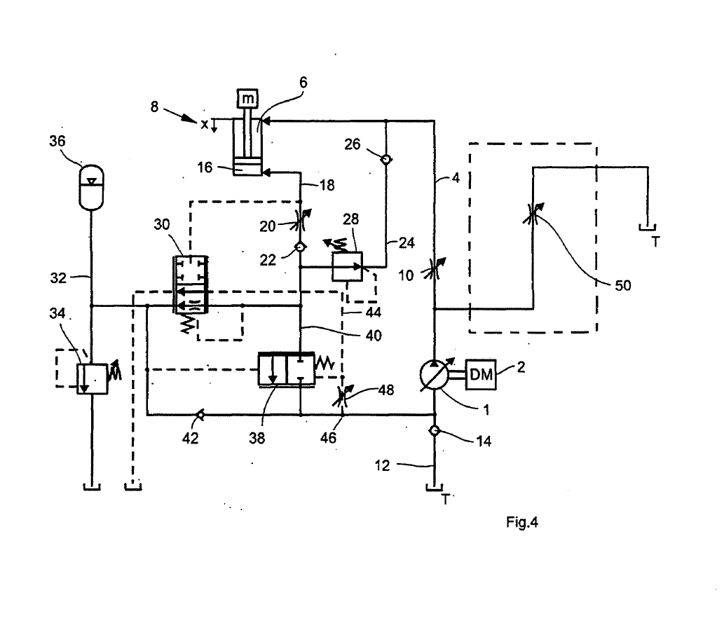

FIG. 4 shows the connection diagram of a hydraulic drive device according to a fourth preferred exemplary embodiment of the invention, which in addition to the functions of the third exemplary embodiment is equipped with an additional “virtual consumer”,

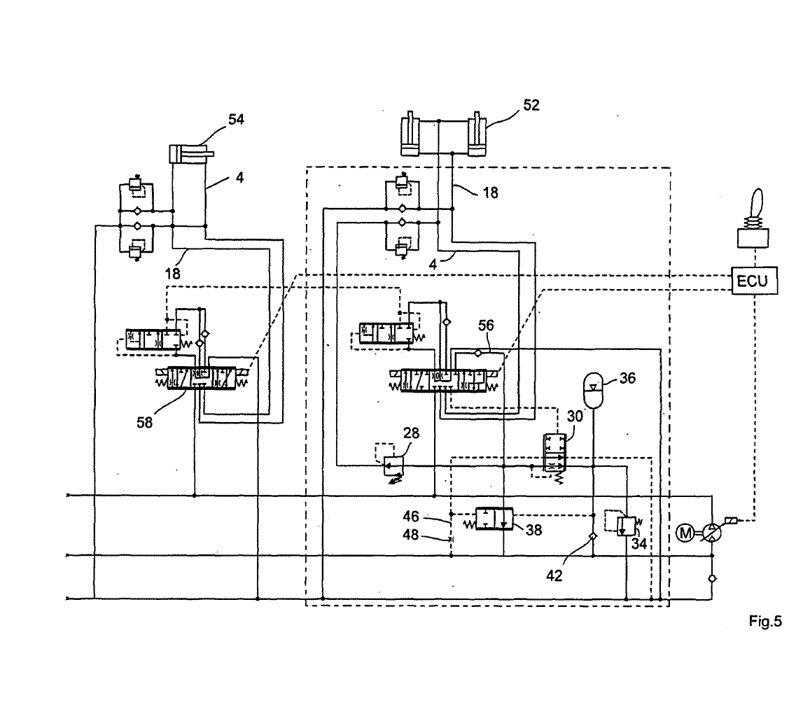

FIG. 5 shows the connection diagram of a hydraulic arrangement according to a fifth preferred exemplary embodiment of the invention and

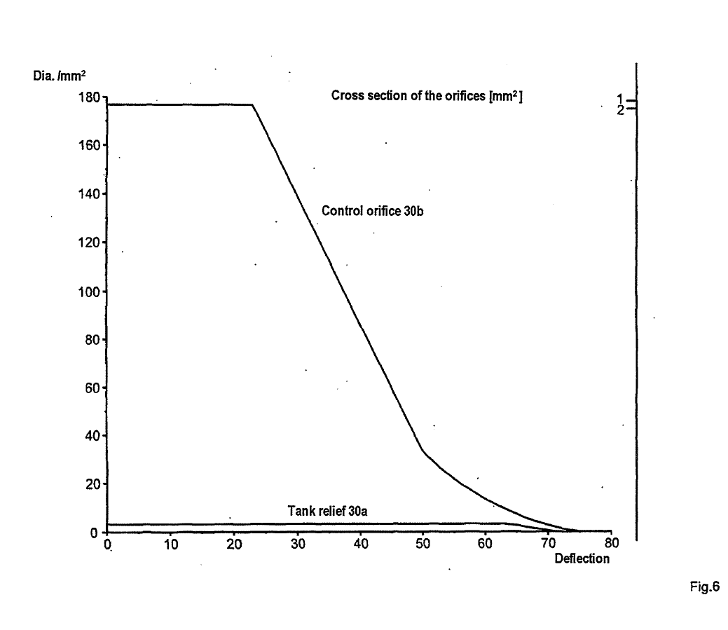

FIG. 6 shows a graph representing the variation of the orifice cross sections of the pressure compensator against the deflection.

In FIG. 1, a connection diagram for a basic version of a hydraulic drive device according to the invention is represented. It should be expressly pointed out at this stage that this diagram forms a simple, but fully operational hydraulic circuit. By contrast with this, the respective diagrams according to FIGS. 2 to 4 do not represent a connection diagram of a fully operational drive device but are merely intended to explain the partial aspect according to the invention of a drive device, that is the partial aspect of “lowering”.

Accordingly, the drive device according to the invention has a preferably variable pressure medium pump 1, which is operated by an electric motor or internal combustion engine 2. The pump 1 can in the present case be connected by way of a feed line 4 to the annular chamber 6 or the piston chamber 16 of a lifting cylinder 8, a controllable proportional valve 9 being interposed in the feed line 4. Furthermore, the pump 1 has an intake line 12 with an interposed check valve 14, which only allows pressure medium to be taken in from a fluid tank in the direction of the pump 1.

From a piston chamber 16 of the lifting cylinder 8 there extends a return line 18, in which the proportional valve 9 is likewise interposed. By way of this valve 9, the piston chamber 16 of the lifting cylinder can be connected in a selected way to the pump 1 by way of the lines 4 and 18, in order to raise a load. In this switching position of the valve 9, the annular chamber 6 is connected to the tank. Furthermore, the piston chamber 16 may be connected by way of the return line 18 and the valve 9 interposed in the return line 18 to the fluid tank for a lowering of the load, in this case the annular chamber 6 being brought into connection with the pump 1 by way of the valve 9. The valve 9 thereby forms (in the lowering position) a kind of run-off control edge or run-off metering orifice 20 in the return line 18, in order to control the lowering operation with precision.

As an alternative to the lifting cylinder 8, also shown in FIG. 1 is a rotation consumer in the form of a hydraulic machine, to which for example a cable winch is coupled. However, for the sake of simplicity, the invention is described below only on the basis of the lifting cylinder.

Downstream from the run-off control edge 20, in the return line 18 there may be arranged a check valve 22 (see FIG. 2 in particular), which only allows pressure medium to flow out from the piston chamber 16 of the lifting cylinder 8. Upstream of this check valve 22, a bypass line 24 branches off, returns by way of a further check valve 26 to the annular chamber 6 and consequently only allows a fluid flow out of the piston chamber 16 into the annular chamber 6. Connected directly upstream of the check valve 26 in the bypass line 24 is a pressure reducing valve 28, the one control side of which is acted on by a preferably adjustable spring and the other control side of which is acted on by a control pressure, which is taken from the bypass line 24 downstream from the pressure reducing valve 28.

Interposed in the return line 18 upstream of the run-off control edge 20 (of the valve 9) is a pressure compensator 30. This pressure compensator 30 preferably comprises a 2-way proportional control valve, the one control side of which is spring-preloaded and acted on by a control pressure which is taken from the return line 18 directly upstream of the pressure compensator 30 and the other control side of which is acted on by a control pressure which is taken from the return line 18 upstream of the run-off control edge 20.

Downstream from the pressure compensator 30, the return line 18 is connected to the intake line 12 of the pressure medium pump 1, to be precise between the pressure medium pump 1 and the check valve 14 in the intake line 12. Finally, a pressure relief line 32, which leads to the fluid tank and in which a pressure limiting valve 34 is interposed, branches off from the return line 18 downstream from the pressure compensator 30. The one control side of the pressure limiting valve 34 is preloaded by a preferably adjustable spring and the other control side is acted on by a control pressure which is taken from the pressure relief line 32 directly upstream of the pressure limiting valve 34.

The output of the pressure compensator 30 is preloaded by the pressure limiting valve 34 to a value that can be set or is preset on the pressure limiting valve 34, so that the suction line 12 also assumes this pressure value upstream of the check valve 14 interposed therein. The pressure medium pump (hydraulic machine) 1 is also intended for supplying pressure medium to both the lifting cylinder 8 represented in FIG. 1, for example of a boom, and further consumers that are not represented any more specifically. Finally, the pressure limiting valve 34 in the pressure relief line 32 is set to such a pressure that corresponds to the lowest load pressure on the lifting cylinder 8 (corresponding substantially to the dead weight of the boom concerned) less a pressure difference over the upstream throttle 20 (or the control edge thereof) that is set by the pressure compensator 30.

The way in which the invention functions in principle can be described as follows on the basis of the schematic drive device according to FIG. 1:

During the lowering of a load, the cylinder piston chamber 16 that is subjected to the load pressure is connected by way of the run-off control edge or run-off metering orifice 20 of the valve 9 and the downstream pressure compensator 30 to the suction line 12 of the pump/motor unit 1. It is possible here to distinguish between the following operating states:
1. The volumetric flow over the run-off metering orifice 20 is greater than the volumetric flow taken from the pump 1.

In this case, a residual amount of pressure medium is diverted by way of the pressure limiting valve 34 (can be set or is set to a fixed value) into the tank and is consequently lost from the energy recovery function. The pressure in the suction line 12 of the pressure medium pump 1 however increases to the pressure set at the pressure limiting valve 34 (for example 50 bar). If the system pressure (after the pump 1) is then higher than the pressure in the pump intake line 12 (pump intake pressure), the pump/motor unit 1 operates as a pump, though with a lower pressure difference over the pump 1 on account of the high intake pressure. As a result, less power has to be demanded from a central drive shaft (between the motor 2 and the pump 1).

If however the system pressure is lower than the pressure in the intake line 12, the pump/motor unit 1 operates as a motor and consequently gives off mechanical power to the central crankshaft. As this happens, the pressure compensator 30 keeps the pressure difference over the throttle (run-off metering orifice) 20 in the return line 18 constant during the lowering of the load and consequently makes lowering that is independent of the load pressure possible.
2. The volumetric flow over the run-off metering orifice 20 is less than the volumetric flow required by the pump 1.

In this operating state, the entire running-off volumetric flow is available to the pump 1. Since then no residual amount of pressure medium is released by way of the pressure limiting valve 34 into the fluid tank, the pressure in the pump intake line 12 falls to the tank pressure. The amount of pressure medium additionally required by the pump 1 can then be taken from the fluid tank by way of the check valve 14 in the suction line 12.

For sufficiently supplying the annular chamber 6 of the cylinder 8, the pressure reducing valve 28 is provided in the bypass line 24 and, if the pressure in the rod chamber 6 goes below a predetermined (predeterminable) value, establishes a connection from the piston chamber 16 to the annular chamber 6 of the lifting cylinder 8 by way of the downstream check valve 26.

As can be deduced in principle from the description above, the potential energy stored in the raised load is made available in the form of pressure energy to the pressure medium pump 1 on the suction side thereof, whereby in one possible operating state the pressure difference over the pump 1 can be reduced and/or in another operating state the pump 1 can even be used as a motor. In this way the efficiency of the device can be increased in comparison with the standard version of the prior art described at the beginning, and at the same time a number of consumers can be supplied with pressure medium by one pump 1.

In FIG. 2, a second preferred exemplary embodiment of the invention is shown, representing a development of the first exemplary embodiment. It is therefore also intended that only those technical features of the second exemplary embodiment that are different from the first exemplary embodiment will be described below. Furthermore, it is intended that the same technical features will be provided with the same designations. It is also once again pointed out that FIG. 2 is only intended to describe the aspect of “load lowering” and does not form a complete hydraulic circuit.

Accordingly, the proportional valve shown in FIG. 1 is replaced by an adjustable throttle 10 in the feed line 4 and a single adjustable run-off metering orifice 20 in the return line 18. The essential innovation of the second exemplary embodiment additionally comprises the arrangement of a pressure accumulator 36 preferably in the pressure relief line 32, which in any event is connected downstream of the pressure compensator 30, but upstream of the pressure limiting valve 34. Consequently, the pressure accumulator 36 could also be connected to the return line 18 or the suction line 12 upstream of the check valve 14 arranged therein. The arrangement of the pressure accumulator 36 has the following effects for the two operating states already mentioned in the first exemplary embodiment:
3. The volumetric flow over the run-off metering orifice 20 is greater than the volumetric flow taken from the pump 1.

In this case, the residual amount of pressure medium is first directed into the pressure accumulator 36, and if this is full, only then by way of the pressure limiting valve 34 into the fluid tank. The pressure on the suction line 12 of the pump 1 thereby increases to the pressure in the pressure accumulator 36.
4. The volumetric flow over the run-off metering orifice 20 is less than the volumetric flow required by the pump 1.

In this operating state, the entire running-off volumetric flow is made available to the pump 1. The amount of pressure medium additionally required by the pump 1 can at least temporarily be taken from the pressure accumulator 36, which thus raises or maintains the pressure on the suction line 12 at least for a certain time (or for a certain amount of fluid removed). Only when the pressure accumulator 36 has been emptied does the pump 1 take pressure medium from the fluid tank, by way of the check valve 14 interposed in the suction line 12.

The check valve 22 connected directly downstream from the run-off metering orifice 20 in the return line 18 has the task in this case of ensuring in all the operating states that there is no reversal of movement if the pressure in the pressure accumulator 36 becomes greater than the pressure on the piston chamber 16 of the cylinder 8.

In FIG. 3, a third preferred exemplary embodiment of the invention is shown, representing a development of the second exemplary embodiment. Therefore only those technical features of the third exemplary embodiment that are different from the second exemplary embodiment are described below. Furthermore, the same technical features are provided with the same designations.

In FIG. 3, an exemplary embodiment with the pressure accumulator 36 already known from FIG. 2 and an additional throttling element 38 is represented. The throttling element 38 is in the present case formed by a proportional valve, which is interposed in a bridge line 40, which connects the return line 18 directly upstream of the pressure compensator 30 to the suction line 12 upstream of the check valve 14. In the present case, the bridge line 40 is connected to the return line 18 directly upstream of the connection point thereof to the suction line 12. Also interposed in the return line 18 is an additional check valve 42, which is positioned upstream of the connection point of the bridge line 40 to the return line 18.

The proportional valve (throttling element) 38 has a first control side, which is acted on by a control pressure which is taken from the return line 18 directly upstream of the pressure compensator 30, and a second control side, which is preloaded by a spring. Also connected on the second control side is a leakage line 44, which leads by way of a relief path 30a in the pressure compensator 30 to the fluid tank. This relief path 30a is released by the pressure compensator 30 whenever the pressure compensator 30 has been opened relatively wide. It should also be pointed out at this stage that the control edge or control orifice of the pressure compensator is denoted by the designation 30b.

Finally, an intermediate line 46, which leads to the leakage line 44 and in which a throttle/nozzle 48 is interposed, branches off from the return line 18 directly downstream from the connection point of the bridge line 40.

The way in which the hydraulic components that are additional in comparison with the second exemplary embodiment operate, in particular the throttling element 38, can be explained most clearly as follows on the basis of the two operating states already mentioned:

During the lowering of a load, the piston chamber 16 of the lifting cylinder 8 that is subjected to the load pressure is connected by way of the throttle/run-off orifice 20, the directly downstream check valve 22 and the throttling element 38 (in this sequence) to the suction line 12 of the central pump/motor unit 1. As already stated, the spring side of the throttling element 38 is also likewise connected by way of the nozzle 48 to the suction line 12 and by way of the leakage line and the relief path 30a in the pressure compensator 30 to the tank. This results in the following functions for the two operating states mentioned:
5. The volumetric flow over the run-off metering orifice 20 is greater than the volumetric flow taken from the pump 1.

In this case, the residual amount of pressure medium is fed by way of the pressure compensator 30 to the hydraulic pressure accumulator 36. As this happens, the pressure compensator 30 keeps the pressure difference over the run-off metering orifice 20 constant and consequently makes lowering that is independent of the load pressure possible.

Since the pressure compensator 30 is in a controlling position, the spring side of the throttling element 38 is connected to the tank. The throttling element 38 is accordingly completely open and establishes by way of the bridge line 40 a connection between the cylinder run-off, i.e. the return line 18 upstream of the run-off metering orifice 20, and the suction line 12 of the pump 1. As a result, the pressure in the pump suction line 12 increases to the piston chamber pressure less the pressure difference or the differential pressure value over the run-off metering orifice 20.

If the system pressure (downstream from the pump 1) is then higher than the pressure in the suction line 12 of the pump 1, the pump/motor unit 1 operates as a pump, though with a lower pressure difference over the pump 1 on account of the increased intake pressure. As a result, less power has to be demanded from the drive shaft. If, however, the system pressure is lower than the pressure in the pump suction line 12, the pump/motor unit 1 operates as a motor and gives off mechanical power to the drive shaft.

It should be pointed out at this stage that, in the case of the third exemplary embodiment, the pressure on the suction line 12 of the pump 1 corresponds to the piston chamber pressure less the pressure difference over the run-off metering orifice 20, and consequently may be greater than the pressure in the pressure accumulator 36. This allows greater utilization of the potential energy becoming free. Only the amount of pressure medium that is not required by the pump 1 (hydraulic machine) is throttled back to the pressure level of the accumulator by way of the pressure compensator 30 and stored in the pressure accumulator 36 or, if the pressure accumulator 36 is full, released into the tank.
6. The volumetric flow over the run-off metering orifice 20 is less than the volumetric flow required by the pump 1.

In this operating state, the entire running-off volumetric flow is made available to the pump 1. Since, however, then no residual amount of pressure medium is fed any longer to the pressure accumulator 36, the pressure compensator 30 closes almost completely. Furthermore, the amount of pressure medium additionally required by the pump 1 must be taken from the accumulator 36 or, if the accumulator 36 is already empty, from the tank. For this purpose, the pressure on the suction line 12 of the pump 1 is throttled down to the level of the accumulator by way of the throttling element 38, in order to be able to take an amount of pressure medium from the accumulator 36 by way of the additional check valve 42 upstream of the connection point of the bridge line 40 to the return line 18. Since, as already stated, in this operating state the pressure compensator 30 is almost completely closed, the pressure relief (leakage line) 44 of the throttling element 38 closes. Consequently, the pressure in the suction line 12 acts on the spring side of the throttling element 38 and the throttling element 38 closes to the extent where the pressure in the suction line 12 corresponds to the pressure of the accumulator. This allows the additional check valve 42 in the return line 18 downstream from the pressure compensator 30 to open and establish a connection from the accumulator 36 into the pump suction line 12. If, finally, the pressure accumulator 36 has been emptied completely, the pressure in the pump suction line 12 falls to the level of the tank, the check valve 14 in the suction line 12 establishing a connection to the tank. The amount of pressure medium additionally required can then be taken from the tank.

In this connection, reference should also be made to the following additional functions of the third exemplary embodiment of the invention:

The check valve 22 connected directly downstream of the run-off metering orifice 20 in the return line 18 ensures in all the operating states mentioned that there is no reversal of movement in the lifting cylinder 8 if the pressure in the pressure accumulator becomes greater than the pressure in the piston chamber 16 of the lifting cylinder 8. The maximum pressure of the accumulator may be set by way of the pressure limiting valve 34 or is pre-set to a fixed value. For sufficiently supplying the annular chamber 6 of the lifting cylinder 8 with pressure medium, use is made of the pressure reducing valve 28, which is interposed in the bypass line 24, as already described on the basis of the first exemplary embodiment. This pressure reducing valve 28 establishes a connection from the piston chamber 16 to the annular chamber 6 of the lifting cylinder 8 by way of the directly downstream check valve 26 if the pressure in the annular chamber 6 goes below a defined pressure value.

Furthermore, the proportional valve or throttling element 38 acts in the above 6th operating state together with the pressure compensator 30 almost as a pre-controlled pressure compensator, the throttling element 38 representing the main stage.

In FIG. 6, the characteristic of the pressure compensator 30 according to the third preferred exemplary embodiment of the invention is represented. In it, the variation of the orifice cross sections 30a and 30b of the pressure compensator 30 is plotted against the deflection of the valve spool. A deflection of 0 mm corresponds here to a completely open control orifice 30b of the pressure compensator 30 and an open tank relief 30a, as shown in FIG. 3.

FIG. 6 reveals that the tank relief, i.e. the relief path 30a, remains completely open over a great deflecting distance and only closes after 6/7 of the maximum deflecting distance (i.e. at about 6.5 mm). With the tank relief completely closed, the pressure compensator 30 still has a residual cross section and can therefore continue to perform its controlling function. In other words, in the operating state described under item 6, the pressure compensator exerts control in the region of the characteristic that is on the right according to FIG. 6 (a valve spool deflection of between 6 mm and 7 mm).

For the purpose of representing more clearly the subject matter of the invention according to the first to third exemplary embodiments, reference should be made hereafter to the accompanying diagram, in which the two operating states mentioned above for each exemplary embodiment are once again compared and contrasted.

| | | | Energy |
|---|---|---|---|
| | | | storage |
| Embodiment | Qₚᵤₘₚ < Q_{run-off} | Qₚᵤₘₚ > Q_{run-off} | possible? |
| Basic | P_{suction} = P_{PLV} | P_{suction} = Pₜₐₙₖ | no |
| embodiment | | | |
| With | P_{suction} = | Accumulator | yes |
| accumulator | P_{accumulator} | full: | |
| | | P_{suction} = | |
| | | P_{accumulator} | |
| | | Accumulator | |
| | | empty: | |
| | | P_{suction} = Pₜₐₙₖ | |
| With | P_{suction} = P_{base} − | Accumulator | yes |
| accumulator | Δp | full: | |
| and | | P_{suction} = | |
| throttling | | P_{accumulator} | |
| element | | Accumulator | |
| | | empty: | |
| | | P_{suction} = Pₜₐₙₖ | |

In FIG. 4, a fourth preferred exemplary embodiment of the invention is shown, representing a development of the third exemplary embodiment. Therefore only those technical features of the fourth exemplary embodiment that are different from the third exemplary embodiment are described below. Furthermore, the same technical features are provided with the same designations.

According to FIG. 4, the hydraulic drive device of the fourth exemplary embodiment of the invention is equipped with an additional “virtual” consumer 50. This “virtual” consumer 50 is intended to make it possible to deliver an additional amount of pressure medium by way of the pump/motor unit 1, even if the amount of pressure medium is not currently required by the actual (classic) consumers. This is meaningful for example whenever the pump/motor unit 1 is in motor mode (excess of energy) and is giving off mechanical power to the drive shaft. In this way, more pressure medium can be forced through the pump/motor unit 1 than is being consumed at the time by the classic consumers, and consequently more power can be given off to the crankshaft. The “virtual” consumer 50 may be, for example, the tank, a further pressure accumulator or similar hydraulic components.

The mechanical power given off to the drive shaft may, for example, also be stored in an additional hybrid module. The “virtual” consumer is then set such that as far as possible the hydraulic machine takes the complete amount of pressure medium that is supplied by the lifting cylinder 8.

In FIG. 5, finally, a fifth preferred exemplary embodiment of the invention is shown. In this figure, the same technical features are likewise provided with the same designations.

In FIG. 5, the hydraulic arrangement with an energy recovery function according to the third preferred exemplary embodiment is shown in combination with a hydraulic drive device for a boom double-lift cylinder and parallel consumer (bucket) 54 as a possible practical exemplary embodiment of the invention, the “boom lifting” function of the double-lift cylinder 54 and the parallel consumer being controlled by the classic LUDV (load-pressure-independent flow distribution) technique. For the “boom lowering” function, the arrangement described above, preferably according to the third exemplary embodiment, is used.

In actual fact, the pressure medium pump 1 is connected to the two aforementioned consumers 52, 54 by way of two proportional valves 56, 58 that can be actuated manually (by way of an ECU) in order to raise them load-independently. Such a hydraulic drive unit (according to the LUDV technique) is sufficiently well known from the prior art, including that of the present applicant, so that at this stage there is no need for a detailed description. In the “load lowering” case, the correspondingly actuated proportional valve 56, 58 connects the relevant piston chambers of the double-lift cylinder 52 or of the parallel consumer 54 to the return line 18, in which the pressure compensator 30 is interposed and the throttling element 38 is connected thereto in the way described according to the third exemplary embodiment. In this way, according to the operating situation, pressure medium is returned to the suction side of the pressure medium pump 1 in order to recover the energy contained therein.

### LIST OF DESIGNATIONS

1 Pump/motor unit
2 Motor
4 Feed line
6 Annular chamber
8 Lifting cylinder
10 Run-in metering orifice/throttle
12 Intake line
14 Check valve
16 Piston chamber
18 Return line
20 Run-off metering orifice/throttle
22 Check valve
24 Bypass line
26 Check valve
28 Pressure reducing valve
30 Pressure compensator
30a Relief path
   30b Control orifice
32 Pressure relief line
24 Pressure limiting valve
36 Pressure accumulator
38 Throttling element
40 Bridge line
42 Additional check valve
44 Leakage line
46 Intermediate line
48 Throttle
50 Virtual consumer
52 Double-lift cylinder
54 Parallel consumer
56, 58 Proportional valves

1. A hydraulic drive device with an energy recovery function, comprising:
a pressure medium pump for supplying at least one consumer with pressure medium; and
a return line for discharging the pressure medium from the consumer,
wherein the discharged pressure medium is returned under a predetermined or predeterminable recovery pressure to the suction side of the pressure medium pump.

2. The hydraulic drive device as claimed in claim 1, wherein the return line comes from the consumer and enters an intake line of the pressure medium pump.

3. The hydraulic drive device as claimed in claim 2, further comprising:
a valve arranged in the intake line between the entry point of the return line and a pressure medium tank,
wherein the valve is preferably a check valve, that only allows a flow of pressure medium from the tank to the pump.

4. The hydraulic drive device as claimed in claim 2, further comprising:
a pressure compensator in the return line, which opens the return line when there is a predetermined or predeterminable discharge pressure and preferably when there is a predetermined or predeterminable pressure difference over an upstream throttle.

5. The hydraulic drive device as claimed in claim 4, further comprising:
a pressure limiting valve, which is interposed in an overpressure line connected to the return line downstream from the pressure compensator and preloads the output side of the pressure compensator to the predetermined or predeterminable recovery pressure.

6. The hydraulic drive device as claimed in claim 1, further comprising:
a pressure accumulator, which is charged by the volumetric recovery flow.

7. The hydraulic drive device as claimed in claim 6, wherein the pressure accumulator is connected to the suction side of the pressure medium pump.

8. The hydraulic drive device as claimed in claim 4, further comprising:
a throttling element, by means of which a pressure medium connection can be established between the at least one consumer and the suction side of the pressure medium pump.

9. The hydraulic drive device as claimed in claim 8, wherein the throttling element is interposed in a bridge line, which circumvents the pressure compensator.

10. The hydraulic drive device as claimed in claim 9, wherein the throttling element is a proportional valve, the one control side of which can be acted on by a throttled output pressure of the pressure compensator and the other control side of which can be acted on, in a spring-preloaded manner and by way of a control line containing an additional throttle, by a control pressure, which is taken from the output pressure of the throttling element and/or from the already throttled output pressure of the pressure compensator.

11. The hydraulic drive device as claimed in claim 10, wherein:
in a position opening the return line, the pressure compensator releases the pressure from the spring-preloaded control side of the throttling element, and
in a control activity closing the return line, the pressure compensator builds up the control pressure on the spring-preloaded control side of the throttling element.

12. The hydraulic drive device as claimed in claim 1, further comprising:
at least one further consumer, which is supplied with pressure medium by the pressure medium pump.

13. The hydraulic drive device as claimed in claim 12, wherein the further consumer is a pressure medium accumulator or a generator pump.
